(19) United States
(12) Patent Application Publication
(10) Pub. No.: US 2023/0093357 A1
(43) Pub. Date: Mar. 23, 2023

(54) SYSTEMS AND METHODS OF ESTIMATING TORQUE, ROTATIONAL SPEED, AND OVERHUNG SHAFT FORCES USING A MACHINE LEARNING MODEL

(71) Applicant: ABB Schweiz AG, Baden (CH)

(72) Inventors: Stefan Rakuff, Raleigh, NC (US); Marius Rutkevicius, Raleigh, NC (US); Rajib Mikail, Raleigh, NC (US)

(21) Appl. No.: 17/480,960

(22) Filed: Sep. 21, 2021

(51) Int. Cl. B60W 50/04; B60W 10/06

(52) U.S. Cl. CPC B60W 50/045; B60W 10/06; B60W 2510/0657; B60W 2510/0638; B60W 2422/00; B60W 2420/54

(57) ABSTRACT

A method of estimating an operating parameter of industrial mechanical power transmission equipment is provided. The method includes acquiring data of a first parameter of the gearbox using a sensor, inferring a second parameter of a gearbox based on the acquired data of the first parameter by using a machine learning model, wherein the second parameter is of a different type from the first parameter and includes at least one of a torque of the gearbox, a rotational speed of the gearbox, or an overhung shaft force of the gearbox, and outputting the estimated second parameter.

### BACKGROUND

The field of the disclosure relates to inferring operating parameters of a gearbox, and more particularly, to inferring parameters of a gearbox using data of different types of parameters and using a machine learning (ML) model.

A gearbox, e.g., a gear reducer, is a mechanical device that reduces the rotational speed and increases the torque generated by an input power source. Neglecting losses, the ratio between input rotational speed and output rotational speed equals the ratio between output torque and input torque and is constant. In some instances, a gearbox may be part of a mechanical power transmission system. For example, the gearbox changes the rotational speed and torque of the prime mover, e.g., an electric motor, a turbine wheel, or an internal combustion engine, and is located between the prime mover and driven equipment. A gearbox may achieve its intended effect by having an input gear drive an output gear that has more teeth than the input gear, causing the output gear to rotate more slowly and having higher torque. The gearbox may be operatively coupled to and/or include a gearbox sensor system. The sensor system may include one or more sensors that are capable of obtaining sensor information, such as gearbox operating parameters of rotational speed, torque, overhung (radial and axial) forces applied to the input and output shafts.

Known sensor systems are disadvantaged in some aspects and improvements are desired.

### BRIEF DESCRIPTION

In one aspect, a method of estimating an operating parameter of industrial mechanical power transmission equipment is provided. The method includes acquiring data of a first parameter of the gearbox using a sensor, inferring a second parameter of a gearbox based on the acquired data of the first parameter by using a machine learning model, wherein the second parameter is of a different type from the first parameter and includes at least one of a torque of the gearbox, a rotational speed of the gearbox, or an overhung shaft force of the gearbox, and outputting the estimated second parameter.

In another aspect, a parameter estimation system for industrial mechanical power transmission equipment is provided. The system includes a parameter estimation computing device, the parameter estimation computing device including at least one processor in communication with at least one memory device. The at least one processor is programmed to receive data of a first parameter of the power transmission equipment acquired by using a sensor, estimate a second parameter of the power transmission equipment based on the received data of the first parameter by using a machine learning model, wherein the second parameter is of a different type from the first parameter and includes at least one of a torque of the power transmission equipment, a rotational speed of the power transmission equipment, or an overhung shaft force of the power transmission equipment, and output the estimated second parameter.

### DRAWINGS

FIG. 1A is a block diagram of an exemplary parameter estimation system.

FIG. 1B is an exemplary gearbox assembly for the system shown in FIG. 1A.

FIG. 1C is a cross-sectional view of the gearbox taken along line 1C-1C in FIG. 1B.

FIG. 2 is a flow chart of an exemplary method of estimating parameters of a gearbox.

FIG. 3 shows spectra of data acquired by a vibration sensor.

FIG. 4 shows spectra of data acquired by a sound pressure sensor.

FIG. 5 shows the performance of an ML regressor that infers gearbox input torque from vibrations.

FIG. 6 are confusion or correlation matrices of prediction results based on use of the system shown in FIG. 1A to estimate overhung shaft forces of a gearbox.

FIG. 7 is a flow chart of an exemplary process of the method shown in FIG. 2.

FIG. 8 is a block diagram of an exemplary user computing device.

FIG. 9 is a block diagram of an exemplary server computing device.

### DETAILED DESCRIPTION

The disclosure includes systems and methods for inferring operating parameters, such as torque, rotational speed, and overhung shaft forces of a gearbox using an ML model based on data acquired with sensors for measuring different types of parameters. Overhung shaft force may also be referred to as overhung load. A gearbox is used herein as an example for illustration purposes only. Systems and methods described herein may be applied to any industrial mechanical power transmission equipment, such as a motor, bearing, sheave, sprocket, or pulley. Method aspects will be in part apparent and in part explicitly discussed in the following description.

Torque, rotational speed, and/or overhung shaft forces of a gearbox are known as the operating conditions or operating parameters of the gearbox. Sensors measuring torque, rotational speed, and overhung shaft forces of a gearbox are used to monitor or control industrial manufacturing processes or to estimate useful remaining lifetime of the gearbox. Sensors for measuring torque and/or overhung shaft forces are relatively expensive, compared to sensors used in the systems and methods described herein such as vibration sensors (e.g., accelerometers) and sound pressure sensors (e.g., microphones). For example, currently a strain gauge-based torque sensor system may on average cost approximately US$5000, while a microphone or an accelerometer may on average cost less than US$100. Further, installing a sensor for measuring torque, rotational speed, and/or overhung shaft forces is complicated for customers and installation may require the gearbox or neighboring components to be dissembled. Physical space to install sensors of operating parameters may be unavailable as well. For example, installing an input torque sensor may require the motor and gearbox be separated more to make room for the sensor which is not always feasible. In contrast, a microphone or an accelerometer may be readily installed on the gearbox housing or proximate to the gearbox, eliminating the need to disassemble the gearbox to complete installation. At times, a gearbox may include or be configured to include a sensor that measures vibration and/or sound pressure but does not measure torque, rotational speed, and/or overhung shaft forces. In that case, installation of the sensor is not needed, or it is convenient using the systems and methods described herein to infer torque, rotational speed, and/or overhung shaft forces.

Systems and methods described herein provide identification, estimation, deduction, inference, or classification of torque, rotational speed, and/or overhung shaft forces using low-cost sensors. Because the relationship between estimated parameters and measured parameters is undefined or difficult to define but repeatable and reproducible, a machine-learning model is used in the systems and methods described herein. Sensors for measuring vibration and/or sound pressure are used herein as examples for illustration purpose only. The systems and methods described herein may be applied in general to estimate torque, rotational speed, or overhung shaft forces of a gearbox using sensors that do not measure torque, rotational speed, or overhung shaft forces and the parameters measured by the sensors have complicated but repeatable relationship with torque, rotational speed, or overhung shaft forces. Other exemplary sensors may be temperature sensors. The operating parameters may be inferred simultaneously. Only two or one of the three operating parameters may be inferred if the other operating parameters are already known. For example, rotational speed and overhung shaft forces may be constant, where only input or output torque needs to be determined from measured parameters.

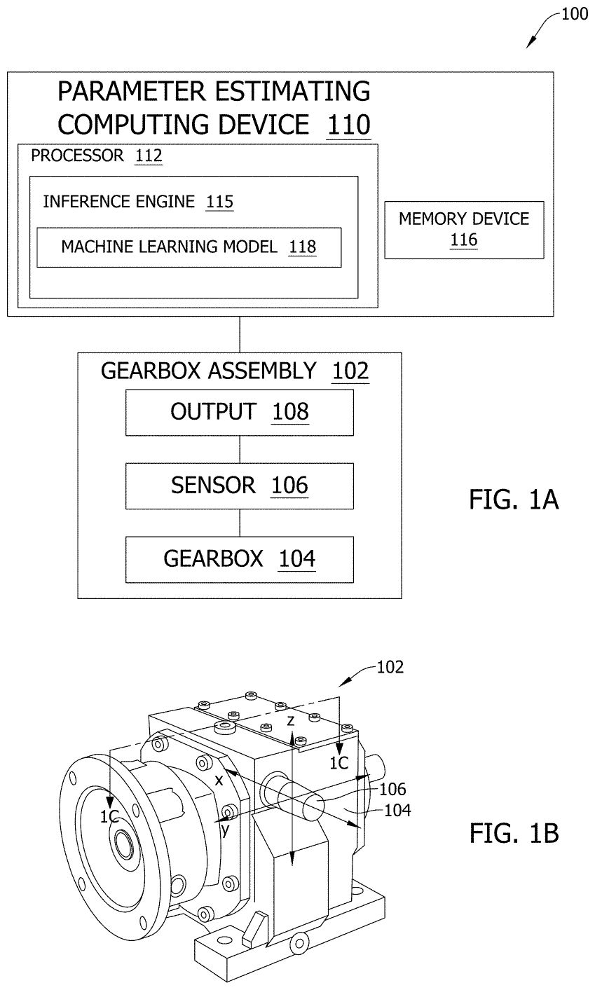

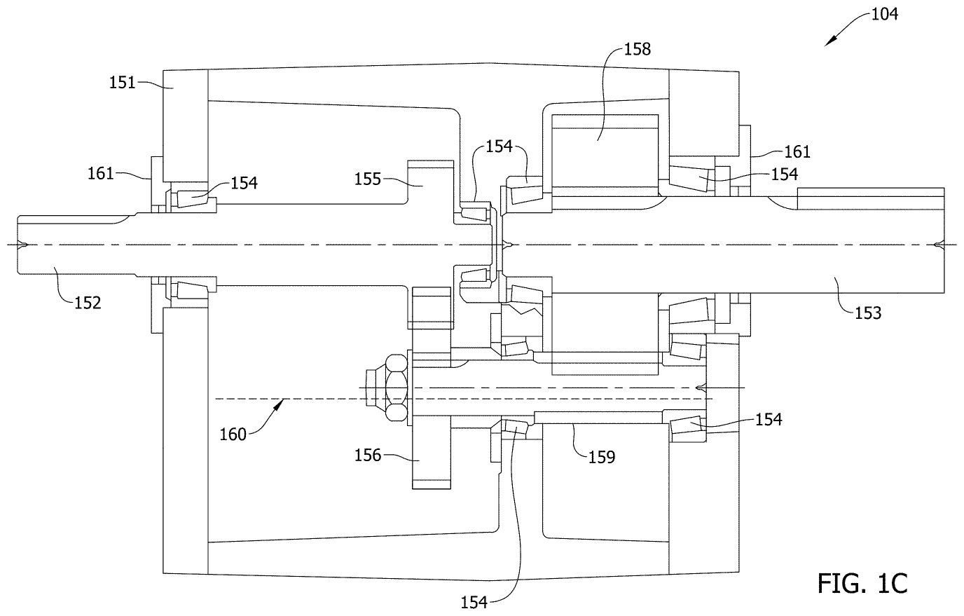

FIGS. 1A-1C show an exemplary parameter estimation system 100 and an exemplary gearbox assembly 102 in parameter estimation system 100. FIG. 1A is a block diagram of parameter estimation system 100. FIG. 1B is a perspective of gearbox assembly 102. FIG. 1C is a cross-sectional view of gearbox assembly 102 along a cross-sectional line 1C-1C as marked in FIG. 1B.

In the exemplary embodiment, system 100 includes gearbox assembly 102. Gearbox assembly 102 includes a gearbox 104. Gearbox assembly 102 may further include one or more sensors 106.

In the exemplary embodiment, gearbox 104 has a housing 151 enclosing the internal movable components (e.g., shafts, gears, and bearings) of gearbox 104 (FIG. 1C). Gearbox 104 includes an input shaft 152 and an output shaft 153. Shafts 152, 153 are partially protruding out of the housing 151 so that the shaft ends may be operatively coupled to other devices, e.g., a prime mover and/or driven equipment. Gearbox 104 may further include an intermediate shaft 159.

Gearbox 104 may be a concentric gear reducer, i.e., with concentric input shaft 152 and output shaft 153. Systems, assemblies, and methods described herein are not limited to a particular design of gearbox, but may be applied to a variety of types and configurations of gearbox and/or machinery. For example, the gearbox may be a parallel shaft, concentric shaft, right-angle input, right-angle output, QUANTIS, MAXUM, MAGNAGEAR, or TORQUE ARM gearbox. The gearbox may also have a variable or adjustable transmission ratio and may include internal components such as clutches, belts, pulleys, capstan rollers, and sheaves.

Systems and methods described herein are not limited to a gearbox, and may be applied to other industrial mechanical power transmission equipment in a mechanical power system or a drivetrain. Other power transmission equipment or machine elements may be a shaft, gear, pulley, belt, chain, sprocket, bearing, keyway, spring, clutch, shaft coupling, or harmonic balancer. A drivetrain including machine elements may increase or decrease the torque or rotational speed or may transmit motion at a constant transmission ratio from a prime mover to a driven load. For example, a drivetrain may include a motor whose shaft is coupled to a driven load with a flexible shaft coupling. Another example of power transmission equipment is a sheave mounted on a motor shaft and another sheave mounted to a shaft of driven equipment. A belt is used to connect the sheaves.

In the exemplary embodiment, gearbox 104 includes a plurality of bearings 154. Bearings 154 are located between shafts 152, 153, 159 and housing 151, and affix shafts with all but one rotational degree of freedom of shaft 152, 153 within housing 151 and allow the shafts to rotate. Bearings 154 are typically rolling element bearings. The bearing may include any suitable type of bearing such as journal bearings or rolling element bearings such as tapered roller bearings, cylindrical roller bearings, and ball bearings.

In the exemplary embodiment, gearbox 104 includes gears 155, 156, 158 affixed to input shaft 152, an intermediate shaft 159, and to output shaft 153. Teeth of adjacent gears operationally mesh with each other such that rotation of input shaft 152 results in intermediate shaft 159 and output shaft 153 also rotating. The gears have particular characteristics and attributes, such as a pitch circle diameter, a working diameter, and number of teeth. By adjusting any of the characteristics or attributes of the gears, various reductions in rotational speed and increases in torque are achieved. For example, if first gear 155 has fewer teeth than second gear 156, intermediate shaft 159 will have a lower rotational speed and higher torque as compared to that of input shaft 152. Output torque may be correlated to input torque, proportional to reduction of rotational speed, except that gearboxes have internal losses which reduce the ideal output torque. The losses originate from friction in the gearbox between components or oil churning losses.

Housing 151 may also contain oil for lubrication and cooling the kinematic components of gearbox 104. The oil may be filled to a defined oil level 160. Seals 161 are located at the openings for input shaft 152 and output shaft 153 to seal interior of housing 151.

In driving equipment, input shaft 152 is operatively coupled to a prime mover, e.g., an electric motor, and output shaft 153 is operatively coupled to driven equipment or a load, e.g., the conveyor, feeder, and/or mill. Gearbox 104 may be configured to reduce the rotational speed at input shaft 152 to output a lower rotational speed at output shaft 153 and to increase the torque applied to input shaft 152 to output a higher torque at output shaft 153. Overhung shaft forces at the input or output shaft act in a radial or axial direction with respect to the shaft axes, and depend on how the prime mover or the driven equipment are connected to the gearbox and on the power transmission process. For example, if a sheave and a vee belt are used to connect the prime mover to the input shaft, a radial force is applied to the input shaft as a result of the belt tensioning under torque. Similar forces result if the driven equipment is connected to the output shaft of the gearbox with, for example, a chain drive.

In the exemplary embodiment, gearbox assembly 102 includes one or more sensors 106. Sensors 106 may be low-cost sensors. For example, sensors 106 may be MEMS accelerometers or microphones. Sensors 106 may be vibration sensors, e.g., piezoelectric accelerometers or laser vibrometers. Sensors 106 may be acoustic sensors or sound pressure sensors, e.g., microphones. Sensor 106 may be an assembly and includes more than one type of sensors. For example, sensor 106 incudes a vibration sensor and an acoustic sensor in one assembly. Sensor 106 may be permanently mounted to gearbox 104. Alternatively, sensor 106 is removably attached to gearbox 104. For example, gearbox 104 provides a coupling mechanism such as a threaded cavity sized to receive a threaded stud protruding from sensor 106 therein (see FIG. 1B). Sensor 106 may be coupled to gearbox through adhesive, e.g., cyanoacrylates, epoxy, or wax. In some embodiments, sensor 106 is not attached to gearbox 104, instead being placed in proximity to gearbox 104.

In other embodiments, in order to decouple data of gearbox 104 from data of the ambient environment, such as vibrations of the surrounding structure, a separate sensor or sensors are used. For example, gearbox 104 is one of the components in a power train that includes drives, motors, couplings, pulleys, belts, and gearboxes. Measured vibration may be not only from gearbox 104, but also from other components in the power train, even if sensor 106 is directly mounted on gearbox 104. A separate sensor 106 may be placed elsewhere in the power train but proximate gearbox 104. The data acquired by separate sensor 106 may be used to decouple the data of gearbox 104 from the data of the ambient condition, e.g., by removing vibration signatures from the ambient condition from the data of gearbox 104. In one embodiment, a plurality of sensors 106 are used in system 100 and each sensor 106 is placed at a different location relative to gearbox 104. Multiple sensors 106 may be used to increase the accuracy of system 100 in estimating torque, rotational speed, and/or overhung shaft forces.

The selection of a sensor to measure structural vibrations or acoustics depends on the frequency range that needs to be measured and the desired sensitivity. Structural vibrations may be measured in terms of displacement, velocity, acceleration, or jerk. Physical parameters may be converted among one another through numerical integration or differentiation. Typically, sensors for low, medium, and high frequencies measure displacements, velocities, and accelerations, respectively.

In one example, structural vibrations are measured. Sensor 106 is a 3-axis (x, y, and z) accelerometer (FIG. 1B). This accelerometer uses a piezoelectric element and an integrated electronics piezo-electric (IEPE) supported analog-to-digital (A/D) converter chip. Sensor 106 has sensitivities of approximately 100 mV/g along each axis (axes x, y, and z) and is mounted to the gearbox housing with a threaded stud. Alternative mounting options include adhesive such as cyanoacrylates (superglue), magnetic bases, or sticky wax. In other embodiments, the sensor may be a non-contact sensor type such as a laser vibrometer or a capacitance gage. In a further embodiment, the sensor is a low-cost 3-axis micro-electromechanical system (MEMS) accelerometer.

Similarly, there are several ways to measure airborne sound pressure with a microphone, which may be classified as free field, pressure field, and random-incidence microphones. A random-incidence microphone may be used when sound comes from different locations on gearbox 104. The dynamic range of the microphone includes the audible frequency range from 20 Hz to 20 kHz or inaudible frequency range of above 20 kHz for ultrasound microphones. The dynamic range of the microphone may be further limited to a frequency range of interest, such as from zero to 4 kHz or from zero to 1500 Hz. In one example, sound waves emitted by the gearbox are measured with a microphone. The microphone has a sensitivity of 14 mV/Pa and a frequency range of 20 Hz-20 kHz.

System 100 may further include an output 108 that is a communication device. Information developed by sensor 106 such as measurements is communicated to the output 108. Output 108 sends the information to other devices through wired communication such as Ethernet, or through wireless communication such as Wi-Fi, Bluetooth, or through radio waves. Output 108 may be part of sensor 106 or part of gearbox 104. Output 108 may be positioned in sensor 106 or gearbox 104, or separately from gearbox 104 or sensor 106.

The system 100 further includes a parameter estimation computing device 110. In one example, computing device 110 is a computing device located remotely from gearbox 104. In some embodiments, computing device 110 is located on gearbox 104 or in sensor 106. In other embodiments, computing device 110 is located outside and proximate gearbox 104, or on a remote server, such as a cloud server.

The computing device 110 is configured to process measured data sent from gearbox assembly 102. For example, computing device 110 is configured to process the measured data by sensor 106. In another example, computing device 110 is configured to estimate torque, rotational speed, and/or overhung shaft forces of gearbox 104 based on vibration data and/or sound pressure data measured by sensor 106.

In the exemplary embodiment, computing device 110 includes a processor 112 having an inference engine 115, and a memory device 116. The inference engine 115 is configured to estimate parameters of gearbox 104 based on data measured by sensor 106. The estimated parameters and the measured parameters are of different types. For example, the estimated parameters are torque, rotational speed, and/or overhung shaft forces of gearbox 104, while measured parameters are vibration and/or sound pressure of gearbox 104 during operation.

In the exemplary embodiment, inference engine 115 includes an ML model 118. ML model 118 is configured to carry out the function of inference engine 115 such as estimating operating parameters based on data measured by sensor 106 of different types of parameters from the estimated parameters. ML model 118 uses supervised learning. Machine learning model 118 may be a classifier or a regressor. In case of a classifier, the data is arranged into a plurality of equally sized or unequally sized bins or classes. The bin sizes and number of bins may be adjusted to meet a predetermined accuracy and/or success rate level. A success rate used herein is the percentage of times an ML model predicts estimated parameters correctly based on the measured data. A smaller bin size may increase the prediction accuracy but may decrease the success rate. ML algorithms used for classification, such as support vector machines, decision trees, random forests, logistic regression, and convoluted neural networks, may be used for ML model 118. In one example, a classifier support vector machine algorithm is used in ML model 118 to identify the torque transmitted by the gearbox based on a vibration or sound spectrum. In one embodiment, ML model 118 is fitted or trained using the method of stochastic gradient descent. The training data contains pairs of known torques and corresponding vibration spectra.

Training data may be collected from a vibration sensor that is attached to a representative gearbox setup in the lab. The lab test setup also includes torque sensors, overhung shaft force sensors, and rotational speed sensors. A lot of data may be collected to train and test an ML model. For example, if all operating parameters are to be inferred at once, then the training data needs to sweep through many of the possible combinations of the operating parameters while collecting vibration data. If the rotational speed and overhung shaft forces are fixed, then the gearbox needs to be operated at different torques to collect vibration data. The model may be tested by using some of the data from the lab that has not yet been used for training. If the model performs successfully then the model may be deployed to be used in the field with gearboxes that do not have force or torque sensors. Another approach to obtain training data may be using sensors to obtain outputs in the field for training the ML model. Sensors may be torque meters, motor current and/or voltage measurements, or measurements from motor drives. These sensors may not need to be kept in the field after initial data collection is completed. If sensors are permanent, the training may be carried out multiple times during the usage period of the product.

The parameter estimation computing device 110 may be a server computing device. In some embodiments, parameter estimation computing device 110 is a user computing device. In one embodiment, parameter estimation computing device 110 is cloud-based or edge-computing based. The parameter estimation computing device 110 may communicate with gearbox assembly 102 through wireless communication. Alternatively, computing device 110 may communicate with gearbox assembly 102 through wired communication. Gearbox assembly 102 may upload data stored in memory device of gearbox assembly 102 such as in sensor 106 to computing device 110 periodically. In some embodiments, gearbox assembly 102 uploads the data in real time to computing device 110.

In some embodiments, parameter estimation computing device 110 includes a processor-based microcontroller including a processor 112 and a memory device 116 wherein executable instructions, commands, and control algorithms, as well as other data and information needed to satisfactorily operate parameter estimation system 100, are stored. Memory device 116 may be, for example, a random access memory (RAM), and other forms of memory used in conjunction with RAM memory, including but not limited to flash memory (FLASH), programmable read only memory (PROM), and electronically erasable programmable read only memory (EEPROM).

As used herein, the term “processor-based” microcontroller shall refer not only to controller devices including a processor or microprocessor as shown, but also to other equivalent elements such as microcomputers, programmable logic controllers, reduced instruction set circuits (RISC), application specific integrated circuits and other programmable circuits, logic circuits, equivalents thereof, and any other circuit or processor capable of executing the functions described below. The processor-based devices listed above are exemplary only, and are thus not intended to limit in any way the definition and/or meaning of the term “processor-based.”

In operation, parameters of gearbox 104 are measured by sensor 106. The data are transmitted to parameter estimation computing device 110. Parameter estimation computing device 110 then estimates parameters of gearbox 104 based on the measured data. The measured data are of parameters of types different from those of estimated parameters.

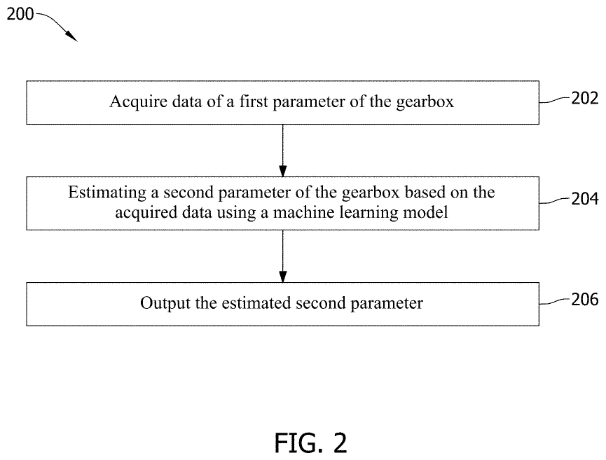

FIG. 2 is a flow chart of an exemplary method of estimating 200 a parameter of a gearbox. Method 200 includes acquiring 202 data of a first parameter of the gearbox using a sensor. The sensor includes a vibration sensor, a sound pressure sensor, or both. Method 200 may include pre-processing the acquired data. Pre-processes may include a Fourier transformation, an order reduction operation such as principal component analysis, and a scaling operation such as a min-max scaler or a standard scaler. The order reduction reduces the number of features from the total number of frequencies in the Digital Fourier Transform (DFT) to a number that is significantly lower. Method 200 also includes estimating 204 a second parameter of the gearbox based on the acquired data or pre-processed data of the first parameter by using an ML model. The second parameter includes a torque, rotational speed, overhung shaft forces of the gearbox, or any combination thereof. Quality of the measured data affects the success rate of estimating the second parameter. For example, noisy measured data may have a reduced success rate, compared to measured data having less noise. Because a sound pressure sensor such as a microphone tends to pick up sound pressure from sources other than the gearbox, measurements by a sound pressure sensor may be noisier than measurements by vibration sensors. The mounting mechanisms and locations of sensor 106 also affect quality of the measurements. For example, measurements from sensors directly mounted on gearbox 104 typically have a higher quality than measurements from sensors mounted or positioned elsewhere. In another example, measurements from sensors coupled through mechanical coupling mechanism such as threaded studs have higher quality than measurements from sensors coupled through adhesive or wax. Further, Method 200 includes outputting 206 the estimated second parameter.

A Fast Fourier Transformation (FFT) algorithm may be used to transform the vibration data from the sensor (accelerometer) from the time domain to the frequency domain. In some embodiments, an FFT is not applied to temperature data. The transformation of the vibration signal may result in a Discrete Fourier Transform (DFT) spectral frequencies that each have an associated amplitude or peak. The frequencies of the DFT are the features for the ML algorithm. The spacing between frequencies and the number of frequencies depends on the sampling rate and bandwidth of the sensor and data acquisition system. Each frequency of the DFT is used as a feature for the ML Algorithm. In one embodiment 1024 features are used. The number of features or dimensionality of the problem may be reduced, e.g., through principal component analysis, to arrive at a potentially simpler ML model that may have faster predictive performance.

In some embodiments, acquiring 202 data and estimating 204 a second parameter are repeated a plurality of times and a plurality of estimated second parameters are derived. The output second parameter is generated based on the plurality of estimated second parameters using a predetermined rule. For example, the rule may include selecting the output second parameter as the estimated second parameter that has been repeated most frequently among the estimated second parameters. Alternatively, estimated second parameters having repeated for a number of times above a predetermined threshold are selected, and the output second parameter is the average of the selected second parameters.

In one example, data of gearbox 104 are acquired by sensor 106. Sensor 106 may be microphones, vibration, and/or temperature sensors. A data acquisition system (not shown) is used to read sensor signals from gearbox 104. The data acquisition system may be part of gearbox assembly 102, part of parameter estimation computing device 110, or a stand-alone system from gearbox assembly 102 or parameter estimation computing device 110 and in communication with gearbox 104 and parameter estimation computing device 110. The data transfer is wired or wireless. An exemplary data acquisition system is a CompactDAQ chassis with an IEPE compatible 4-channel input module. Software such as LabVIEW and a user computing device are used to control the data acquisition system.

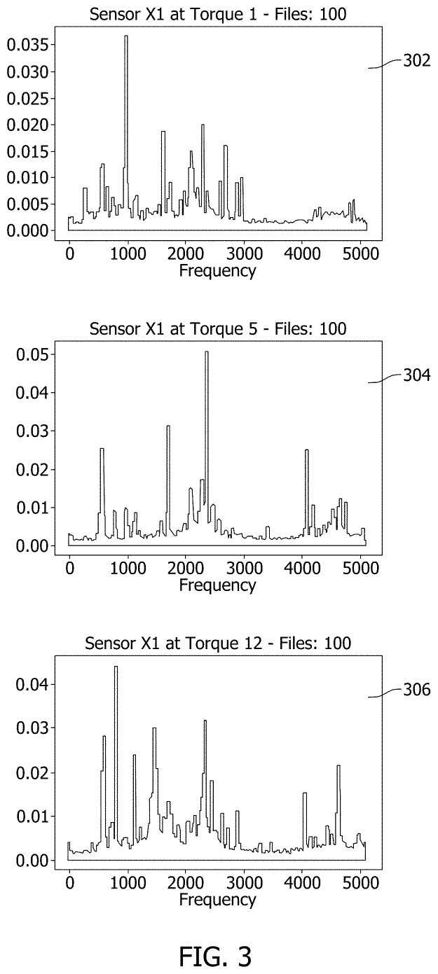

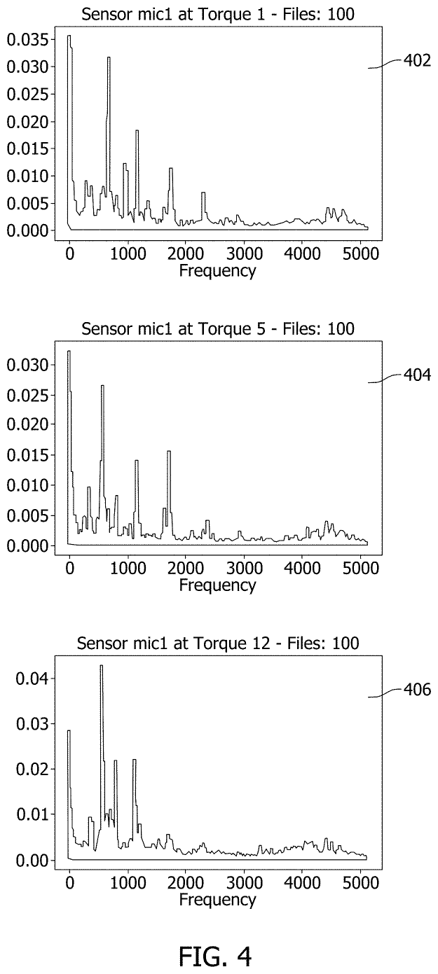

In some embodiments, parameter estimation computing device 110 is a computing platform, such as an edge or cloud computer, and used to process the sensor data and run the ML algorithms. Computing device 110 is used to calculate the digital Fourier transform (DFT) of the time domain signals coming from the sensor using a fast Fourier transform (FFT) algorithm. The Fourier transformed data are the frequency spectrum of the measured data. The power spectra of the signals are calculated from the Fourier transformed data. Example spectra in the x-direction (see FIG. 1B) are provided in FIGS. 3 and 4. For generating the spectra shown in FIGS. 3 and 4, the measured data were sampled at a sampling rate of 10 kHz.

FIG. 3 shows 100 superimposed spectra from accelerometer axis x with a low torque (plot 302), medium torque (plot 304), and high torque (plot 306) at 1750 rpm (and zero overhung shaft force). The superimposed spectra show that for a given torque value, distinct peaks are present and unique to the torque level. While the peak heights may vary, the frequencies of the peaks are repeatable and reproducible among the same torque data.

FIG. 4 shows spectra that were obtained with a microphone. 100 superimposed spectra from the microphone are shown, with a low torque (plot 402), medium torque (plot 404), and high torque (plot 406), respectively. Similar observations may be made regarding peak locations and peak heights. That is, for the same level of torque, the spectra of the data acquired by a microphone have peaks at consistent frequencies.

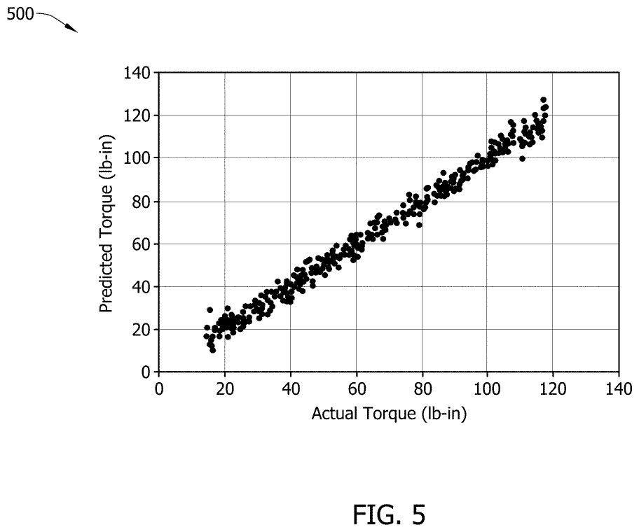

FIG. 5 shows an example of predicted (inferred) torques over actual (true) input torque values obtained with a regressor ML model. In the exemplary embodiment, spectra of the measured vibration data collected by sensor 106 are used to infer torque, rotational speed, or overhung shaft forces of gearbox 104. In one example, a total of 1400 spectra from a vibration sensor (e.g., an accelerometer) corresponding to different torque levels were used at 1750 rpm input rotational speed to train ML model 118. The spectra contain 2048 frequencies that are used as features for the ML algorithm. The torque was continuously varied from a low to a high torque value while collecting the data. A subset of the data of 1000 spectra is used as a training data set. The data was randomly shuffled and processed. The processing may be a scaling such that the data falls between −1 and +1 or 0 and +1, or may be normalization such that the mean is zero and the variance is 1. The feature size was reduced from 2048 to 50. The remaining four hundred (400) spectra with known torque values that were not used for training are used to test ML model 118. In this embodiment the ML model is a state vector machine regressor fitted with the method of stochastic gradient decent. The results of the test are represented with a graph 500 in FIG. 5. The abscissa of a point on the graph represents the true torque value, and the ordinate of a point represents the inferred torque value. The fitted ML model has an R-squared value of over 98 percent.

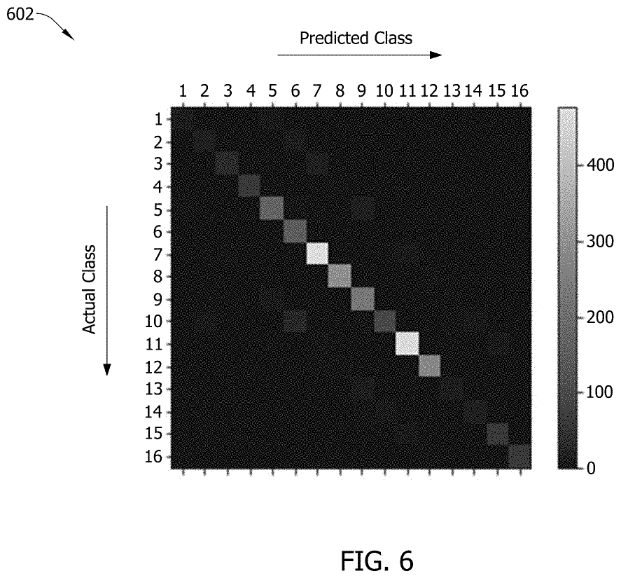

FIG. 6 shows a confusion (or correlation) matrix illustrating predicted parameters versus actual parameters using a classifier. In this example, the speed varied between 500 and 1800 rpm, and the input torque varied from 0 to 14.7 Newton-meter (N-m) (130 lb-in). Over 4400 spectra obtained from a low cost MEMS accelerometer are used for simultaneous inference of torque and speed and zero (constant) overhung shaft loads. Sixty percent of the spectra are used for training and 40 percent of the spectra were used for testing of the ML algorithm. In this example, the ML model is a support vector machine classifier. The speeds and torques are binned into four speed and four torque classes, respectively. Classes for the ML algorithm are formed by forming all possible combinations of speed and torque classes, resulting in a total of 16 classes. Therefore, the confusion matrix is a 16 by 16 matrix. The performance of the classifier algorithm is shown in confusion matrix 602 in FIG. 6. The success rate is 92 percent.

Results (not shown) presented in a manner similar to the results of FIGS. 4 and 5 are obtained in estimating speed of gearbox 104 using the systems, assemblies, and methods described herein.

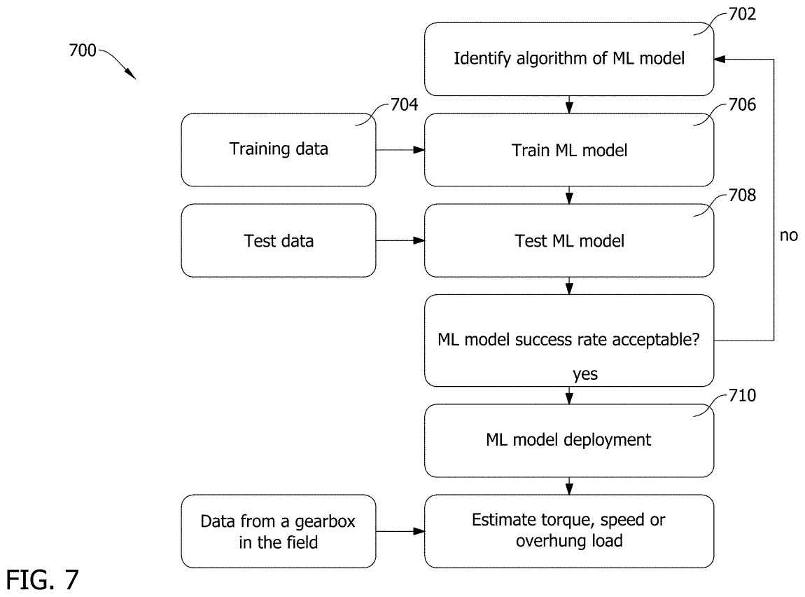

FIG. 7 is a flow chart of the exemplary embodiment of a process 700 for estimating 200 rotational speed, overhung shaft forces, and/or torques. In the following the process, torque identification is described as an example for illustration only. The process may be applied to estimating rotational speed and/or overhung shaft forces. In the exemplary embodiment, process 700 includes identifying 702 an algorithm of the ML model. The algorithm may be a classifier based on random forests, decision trees, logistic regression, or support vector machines. For example, the algorithm for ML model may be a classifier using a support vector algorithm. Process 700 also includes obtaining 704 training data by collecting spectra at different known toque levels. Data processing such as normalization of amplitudes and shifting the data to have a zero mean in the data may be applied. The data are used to fit or train 706 the ML model using a training method such as stochastic gradient decent. The accuracy of the algorithm is then tested 708 by using test data. The test data contains spectra with known torque labels that were not yet used during training. If the accuracy is unsatisfactory, process 700 goes back to selecting 702 different parameters of the algorithm or a different algorithm and start again. If the accuracy is satisfactory, the ML module is deployed 710 to estimate the torque, overhung shaft force, or rotational speed of the gearbox using data acquired in the field.

Table 1 below shows a summary of the success rates obtained with a state vector machine classifier algorithm fitted to vibration data using the stochastic gradient decent method. Data from different accelerometers or microphones is compared by collecting 815 measurements (i.e., spectra) from each sensor. The output torque was varied between 436.1 N-m (3860 lb-in) and 31.6 N-m (280 lb-in) by a variable frequency drive controlling the motor connected to the input shaft of the gearbox and an adjustable load connected to the output shaft of the gearbox while the rotational speed and overhung shaft forces are kept constant at 1750 rpm and 0, respectively, during the test. Twenty eight equally sized torque classes, or bins, are defined. For each sensor, the data is divided into 600 training data files and 215 test data files. The algorithm is fitted or trained using the training data.

The trained algorithm is then used to classify torques using the training and test data sets. The column “Success Rate (Training Data)” shows a percentage of correct guesses by ML model 118 when the training data is used. The column “Success Rate (Test Data)” shows a percentage of correct guesses by ML model 118 with the test data set. The success rates from the test data are generally lower than the success rates from the training data because the test data is new data that has not been seen by the algorithm before. In producing Table 1, two 3-axis accelerometers (axes x1, y1, z1 and axes x2, y2, z3) and two single-axis accelerometers (Acc1 and Acc2) and two sound pressure sensors (Mic1 an Mic2) are used. The sensors are placed at different locations. As shown in Table 1, using vibration sensors provides a higher success rate than using a sound pressure sensor. The success rates of the algorithm may be affected by changing the number of spectra, i.e., the number of spectra in a training dataset, or by changing the split between training and test data.

TABLE 1

| | Success Rate | Success Rate |
|---|---|---|
| Sensor | (Training Data) | (Test Data) |
| x1 | 94.0 | 81.9 |
| y1 | 95.2 | 76.7 |
| z1 | 94.3 | 82.3 |
| x2 | 94.8 | 83.3 |
| y2 | 93.5 | 77.2 |
| z2 | 94.8 | 85.1 |
| Acc1 | 96.0 | 84.2 |
| Acc2 | 96.8 | 83.7 |
| Mic1 | 94.5 | 81.4 |
| Mic2 | 95.2 | 83.7 |

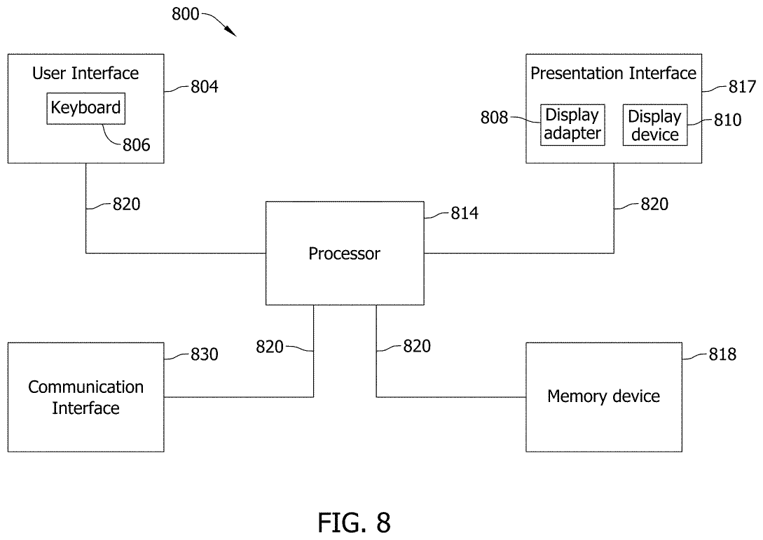

The parameter estimation computing device 110 described herein may be any suitable user computing device 800 and software implemented therein. FIG. 8 is a block diagram of an exemplary computing device 800. In the exemplary embodiment, the computing device 800 includes a user interface 804 that receives at least one input from a user. The user interface 804 may include a keyboard 806 that enables the user to input pertinent information. The user interface 804 may also include, for example, a pointing device, a mouse, a stylus, a touch sensitive panel (e.g., a touch pad and a touch screen), a gyroscope, an accelerometer, a position detector, and/or an audio input interface (e.g., including a microphone).

Moreover, in the exemplary embodiment, computing device 800 includes a presentation interface 817 that presents information, such as input events and/or validation results, to the user. The presentation interface 817 may also include a display adapter 808 that is coupled to at least one display device 810. More specifically, in the exemplary embodiment, the display device 810 may be a visual display device, such as a cathode ray tube (CRT), a liquid crystal display (LCD), a light-emitting diode (LED) display, and/or an “electronic ink” display. Alternatively, the presentation interface 817 may include an audio output device (e.g., an audio adapter and/or a speaker) and/or a printer.

The computing device 800 also includes a processor 814 and a memory device 818. The processor 814 is coupled to the user interface 804, the presentation interface 817, and the memory device 818 via a system bus 820. In the exemplary embodiment, the processor 814 communicates with the user, such as by prompting the user via the presentation interface 817 and/or by receiving user inputs via the user interface 804. The term “processor” refers generally to any programmable system including systems and microcontrollers, reduced instruction set computers (RISC), complex instruction set computers (CISC), application specific integrated circuits (ASIC), programmable logic circuits (PLC), and any other circuit or processor capable of executing the functions described herein. The above examples are exemplary only, and thus are not intended to limit in any way the definition and/or meaning of the term “processor.”

In the exemplary embodiment, the memory device 818 includes one or more devices that enable information, such as executable instructions and/or other data, to be stored and retrieved. Moreover, the memory device 818 includes one or more computer readable media, such as, without limitation, dynamic random access memory (DRAM), static random access memory (SRAM), a solid state disk, and/or a hard disk. In the exemplary embodiment, the memory device 818 stores, without limitation, application source code, application object code, configuration data, additional input events, application states, assertion statements, validation results, and/or any other type of data. The computing device 800, in the exemplary embodiment, may also include a communication interface 830 that is coupled to the processor 814 via the system bus 820. Moreover, the communication interface 830 is communicatively coupled to data acquisition devices.

In the exemplary embodiment, the processor 814 may be programmed by encoding an operation using one or more executable instructions and providing the executable instructions in the memory device 818. In the exemplary embodiment, the processor 814 is programmed to select a plurality of measurements that are received from data acquisition devices.

In operation, a computer executes computer-executable instructions embodied in one or more computer-executable components stored on one or more computer-readable media to implement aspects of the disclosure described and/or illustrated herein. The order of execution or performance of the operations in embodiments of the disclosure illustrated and described herein is not essential, unless otherwise specified. That is, the operations may be performed in any order, unless otherwise specified, and embodiments of the disclosure may include additional or fewer operations than those disclosed herein. For example, it is contemplated that executing or performing a particular operation before, contemporaneously with, or after another operation is within the scope of aspects of the disclosure.

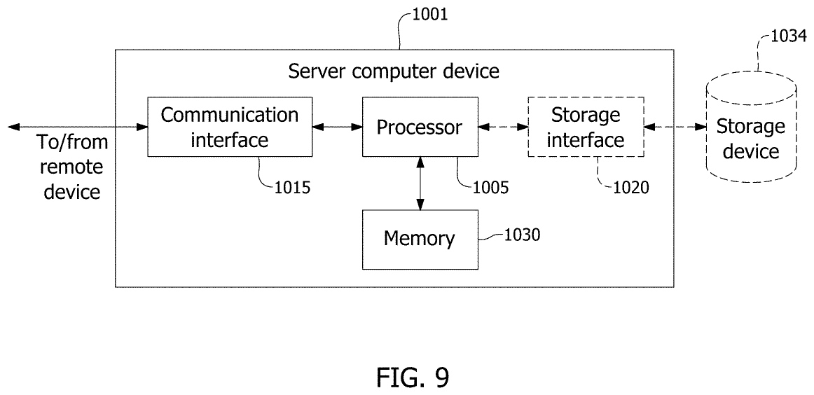

FIG. 9 illustrates an exemplary configuration of a server computer device 1001 such as parameter estimation computing device 114. The server computer device 1001 also includes a processor 1005 for executing instructions. Instructions may be stored in a memory area 1030, for example. The processor 1005 may include one or more processing units (e.g., in a multi-core configuration).

The processor 1005 is operatively coupled to a communication interface 1015 such that server computer device 1001 is capable of communicating with a remote device such as gearbox assembly 102, sensor 106, or another server computer device 1001. For example, communication interface 1015 may receive data from parameter estimation computing device 110 and sensor 106, via the Internet.

The processor 1005 may also be operatively coupled to a storage device 1034. The storage device 1034 is any computer-operated hardware suitable for storing and/or retrieving data, such as, but not limited to, wavelength changes, temperatures, and strain. In some embodiments, the storage device 1034 is integrated in the server computer device 1001. For example, the server computer device 1001 may include one or more hard disk drives as the storage device 1034. In other embodiments, the storage device 1034 is external to the server computer device 1001 and may be accessed by a plurality of server computer devices 1001. For example, the storage device 1034 may include multiple storage units such as hard disks and/or solid state disks in a redundant array of inexpensive disks (RAID) configuration. The storage device 1034 may include a storage area network (SAN) and/or a network attached storage (NAS) system.

In some embodiments, the processor 1005 is operatively coupled to the storage device 1034 via a storage interface 1020. The storage interface 1020 is any component capable of providing the processor 1005 with access to the storage device 1034. The storage interface 1020 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing the processor 1005 with access to the storage device 1034.

The computer-implemented methods discussed herein may include additional, less, or alternate actions, including those discussed elsewhere herein. The methods may be implemented via one or more local or remote processors, transceivers, servers, and/or sensors, and/or via computer-executable instructions stored on non-transitory computer-readable media or medium.

Additionally, the computer systems discussed herein may include additional, less, or alternate functionality, including that discussed elsewhere herein. The computer systems discussed herein may include or be implemented via computer-executable instructions stored on non-transitory computer-readable media or medium.

In some embodiments, the design system is configured to implement an ML algorithm that “learns” to analyze, organize, and/or process data without being explicitly programmed. ML may be implemented through ML methods and algorithms. In an exemplary embodiment, an ML module is configured to implement ML methods and algorithms. In some embodiments, ML methods and algorithms are applied to data inputs and generate ML outputs. The “learning” is performed by fitting parameters of an ML algorithm to known input and output data pairs. This type of ML is known as supervised learning. Data inputs may include but are not limited to analog and digital signals (e.g., sound, light, motion, or natural phenomena) Data inputs may further include sensor data, image data, video data, and telematics data. ML outputs may include but are not limited to digital signals (e.g., information data converted from natural phenomena). ML inputs or outputs may further include: speech recognition, image or video recognition, statistical or financial models, autonomous vehicle decision-making models, robotics behavior modeling, signal detection, fraud detection analysis, user input recommendations and personalization, game AI, skill acquisition, targeted marketing, big data visualization. In some embodiments, data inputs may include certain ML outputs.

In some embodiments, at least one of a plurality of ML methods and algorithms may be applied, which may include but are not limited to: linear or logistic regression, instance-based algorithms, regularization algorithms, decision trees, Bayesian networks, cluster analysis, association rule learning, artificial neural networks, deep learning, recurrent neural networks, Monte Carlo search trees, generative adversarial networks, dimensionality reduction, and support vector machines. In various embodiments, the implemented ML methods and algorithms are directed toward at least one of a plurality of categorizations of ML, such as supervised learning, unsupervised learning, and reinforcement learning.

In one embodiment, ML methods and algorithms are directed toward supervised learning, which involves identifying patterns in existing data to make predictions about subsequently received data. Specifically, ML methods and algorithms directed toward supervised learning are trained through training data, which includes example inputs and associated example outputs. Based on the training data, the ML methods and algorithms may generate a predictive function which maps outputs to inputs and utilize the predictive function to generate ML outputs based on data inputs. The example inputs and example outputs of the training data may include any of the data inputs or ML outputs described above. For example, an ML module may receive training data including data associated with different signals received and their corresponding classifications, generate a model which maps the signal data to the classification data, and recognize future signals and determine their corresponding categories.

In another embodiment, ML methods and algorithms are directed toward unsupervised learning, which involves finding meaningful relationships in unorganized data. Unlike supervised learning, unsupervised learning does not involve user-initiated training based on example inputs with associated outputs. Rather, in unsupervised learning, unlabeled data, which may be any combination of data inputs and/or ML outputs as described above, is organized according to an algorithm-determined relationship. In an exemplary embodiment, an ML module coupled to or in communication with the design system or integrated as a component of the design system receives unlabeled data including event data, signal data, and the ML module employs an unsupervised learning method such as “clustering” to identify patterns and organize the unlabeled data into meaningful groups. The newly organized data may be used, for example, to extract further information about the potential classifications.

In yet another embodiment, ML methods and algorithms are directed toward reinforcement learning, which involves optimizing outputs based on feedback from a reward signal. Specifically, ML methods and algorithms directed toward reinforcement learning may receive a user-defined reward signal definition, receive a data input, utilize a decision-making model to generate an ML output based on the data input, receive a reward signal based on the reward signal definition and the ML output, and alter the decision-making model so as to receive a stronger reward signal for subsequently generated ML outputs. The reward signal definition may be based on any of the data inputs or ML outputs described above. In an exemplary embodiment, an ML module implements reinforcement learning in a user recommendation application. The ML module may utilize a decision-making model to generate a ranked list of options based on user information received from the user and may further receive selection data based on a user selection of one of the ranked options. A reward signal may be generated based on comparing the selection data to the ranking of the selected option. The ML module may update the decision-making model such that subsequently generated rankings more accurately predict optimal constraints.

As used herein, the terms “processor” and “computer,” and related terms, e.g., “processing device,” “computing device,” and “controller” are not limited to just those integrated circuits referred to in the art as a computer, but broadly refers to a microcontroller, a microcomputer, an analog computer, a programmable logic controller (PLC), an application specific integrated circuit (ASIC), and other programmable circuits, and these terms are used interchangeably herein. In the embodiments described herein, “memory” may include, but is not limited to, a computer-readable medium, such as a random-access memory (RAM), a computer-readable non-volatile medium, such as a flash memory. Alternatively, a floppy disk, a compact disc-read only memory (CD-ROM), a magneto-optical disk (MOD), and/or a digital versatile disc (DVD) may also be used. Also, in the embodiments described herein, additional input channels may be, but are not limited to, computer peripherals associated with an operator interface such as a touchscreen, a mouse, and a keyboard. Alternatively, other computer peripherals may also be used that may include, for example, but not be limited to, a scanner. Furthermore, in the example embodiment, additional output channels may include, but not be limited to, an operator interface monitor or heads-up display. Some embodiments involve the use of one or more electronic or computing devices. Such devices typically include a processor, processing device, or controller, such as a general purpose central processing unit (CPU), a graphics processing unit (GPU), a microcontroller, a reduced instruction set computer (RISC) processor, an ASIC, a programmable logic controller (PLC), a field programmable gate array (FPGA), a digital signal processing (DSP) device, and/or any other circuit or processing device capable of executing the functions described herein. The methods described herein may be encoded as executable instructions embodied in a computer readable medium, including, without limitation, a storage device and/or a memory device. Such instructions, when executed by a processing device, cause the processing device to perform at least a portion of the methods described herein. The above examples are not intended to limit in any way the definition and/or meaning of the term processor and processing device.

At least one technical effect of the systems and methods described herein includes (a) estimating torque, rotational speed, and/or overhung shaft forces of a gearbox without using a sensor configured to measure those parameters; and (b) reducing costs and installation complexity by using sensors having relatively low cost and being easy to install.

Exemplary embodiments of systems and methods of estimating parameters of a gearbox are described above in detail. The systems and methods are not limited to the specific embodiments described herein but, rather, components of the systems and/or operations of the methods may be utilized independently and separately from other components and/or operations described herein. Further, the described components and/or operations may also be defined in, or used in combination with, other systems, methods, and/or devices, and are not limited to practice with only the systems described herein.

Although specific features of various embodiments of the invention may be shown in some drawings and not in others, this is for convenience only. In accordance with the principles of the invention, any feature of a drawing may be referenced and/or claimed in combination with any feature of any other drawing.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A method of estimating an operating parameter of industrial mechanical power transmission equipment, comprising:
acquiring data of a first parameter of a gearbox using a sensor;
inferring a second parameter of the gearbox based on the acquired data of the first parameter by using a machine learning model, wherein the second parameter is of a different type from the first parameter and includes at least one of a torque of the gearbox, a rotational speed of the gearbox, or an overhung shaft force of the gearbox; and
outputting the estimated second parameter.

2. The method of claim 1, wherein the data include a time series of data points, and estimating a second parameter further comprises:
generating a frequency spectrum of the data by Fourier transforming the time series; and
inferring the second parameter based on the frequency spectrum of the data.

3. The method of claim 1, wherein:
acquiring data further comprises:
acquiring first data of the first parameter of the gearbox using a first sensor; and
acquiring second data of the first parameter of an ambient environment of the gearbox using a second sensor; and
estimating a second parameter further comprises:
decoupling the first data from the second data by removing an ambient condition of the ambient environment in the first data; and
estimating the second parameter based on the decoupled first data.

4. The method of claim 1, wherein estimating a second parameter further comprises:
identifying an algorithm of the machine learning model.

5. The method of claim 1, wherein acquiring data further comprises acquiring data using a plurality of sensors.

6. The method of claim 1, wherein the sensor is a vibration sensor.

7. The method of claim 1, wherein the sensor is a sound pressure sensor.

8. The method of claim 1, wherein the second parameter is the torque of the gearbox.

9. The method of claim 1, wherein the second parameter is the rotational speed of the gearbox.

10. The method of claim 1, wherein the second parameter is the overhung shaft forces of the gearbox.

11. The method of claim 1, wherein the sensor is mounted on the gearbox.

12. The method of claim 1, further comprising repeating acquiring data and estimating a second parameter for a plurality of times, wherein the method further comprises:
generating an output second parameter using estimated second parameters based on a predetermined rule; and
outputting the output second parameter.

13. A parameter estimation system for industrial mechanical power transmission equipment, comprising a parameter estimation computing device, the parameter estimation computing device comprising at least one processor in communication with at least one memory device, and the at least one processor programmed to:
receive data of a first parameter of the power transmission equipment acquired by using a sensor;
estimate a second parameter of the power transmission equipment based on the received data of the first parameter by using a machine learning model, wherein the second parameter is of a different type from the first parameter and includes at least one of a torque of the power transmission equipment, a rotational speed of the power transmission equipment, or an overhung shaft force of the power transmission equipment; and
output the estimated second parameter.

14. The system of claim 13, wherein the data is a time series of data points, and the at least one processor is further configured to:
generate a frequency spectrum of the data by Fourier transforming the time series; and
estimate the second parameter based on the frequency spectrum of the data.

15. The system of claim 13, wherein the power transmission equipment is a gearbox.

16. The system of claim 13, wherein the sensor is a vibration sensor.

17. The system of claim 13, wherein the sensor is a sound pressure sensor.

18. The system of claim 13, wherein the second parameter is the torque of the power transmission equipment.

19. The system of claim 13, wherein the second parameter is the rotational speed of the power transmission equipment.

20. The system of claim 13, wherein the second parameter is the overhung shaft force of the power transmission equipment.
